(19) United States
(12) Patent Application Publication
(10) Pub. No.: US 2015/0314865 A1
(43) Pub. Date: Nov. 5, 2015

(54) CONVERTIBLE AIRCRAFT PROVIDED WITH TWO DUCTED ROTORS AT THE WING TIPS AND WITH A HORIZONTAL FAN IN THE FUSELAGE

(71) Applicant: Gérome BERMOND, (US)

(72) Inventors: Gérome BERMOND, Eze (FR); Etienne VANDAME, Uherske Hradiste (CZ)

(21) Appl. No.: 14/650,231

(22) PCT Filed: Dec. 9, 2013
(86) PCT No.: PCT/FR2013/000326

§ 371 Date: Jun. 5, 2015

(30) Foreign Application Priority Data
Dec. 10, 2012 (FR) 12/03351

(51) Int. Cl. B64C 27/22; B64D 27/02; B64C 27/52

(52) U.S. Cl. CPC B64C 27/22; B64C 27/52; B64D 27/02

(57) ABSTRACT

The invention relates to a convertible aircraft comprising a fuselage (F), a pair of wings (A1, A2) arranged one on each side of the fuselage (F), at least one ducted rotor (1) installed in a horizontal position at one of the ends of the fuselage (F) and a first and a second nacelle (N1, N2) arranged respectively at the tip of each wing (A1, A2) and each comprising a ducted rotor (R1, R2) and being pivotably mounted relative to the fuselage (F). The nacelles comprise at least a first and a second movable flap (V1, V2), which flaps are arranged respectively at the outlet of the ducted rotor (R1) of the first nacelle (N1) and at the outlet of the ducted rotor (R2) of the second nacelle (N2). The aircraft according to the invention thus represents an advantageous solution to any applications involving helicopters and airplanes, particularly emergency preparedness missions, rescue missions, and public or private transport.

The present invention relates to improvements made to convertible aircraft with ducted rotors.

These aircrafts are provided with two tilting ducted rotors, located on each side of the fuselage, which are being called <<nacelle>>. Depending on the position of the nacelles, these aircrafts have the ability to move vertically with a low translation speed, such as helicopters (called “helicopter” mode), and at the same time can translate horizontally at higher speeds, such as airplanes (called “plane” mode).

The benefit of these aircrafts is to offer a multi-purpose propulsion solution, to be less bulky, more silent, more stable and less complex to manufacture than helicopters and convertible aircrafts with open rotors.

However, although many prototypes of convertible aircraft with ducted rotors have been built, none of them has ever reached the mass production stage, due to several adverse technical factors.

In fact, the control of these aircrafts is problematic, because the ducts of the rotors generate a lift as soon as airflow impacts them. The variation of the duct position during the transition phase between the helicopter and the plane modes thus substantially changes the distribution and the intensity of the lift and of the overall drag of the aircraft. Its behavior thus significantly varies, making it sensitive to control. Some control and compensation systems have already been designed. Practically, these systems have proved too complex and/or not effective enough to pass the prototype phase and reach the mass production.

Moreover, from a certain forward speed in plane mode, the surfaces of the ducts inevitably generate a significant drag, which restricts the performances of these aircrafts in comparison with airplanes.

Finally, the weight of the nacelles and the aerodynamic forces which are applied on them, have an adverse impact on the structure and consequently the aircraft weight.

So, there is a substantial need for a convertible aircraft with ducted rotors which limits or resolves at least one of the previously mentioned limitations.

More specifically, the objective of the present invention is to offer a convertible aircraft with ducted rotors, the control of which is bettered for more efficiency and reliablility, while complying with aircraft certification standards, thus allowing mass production and mass consumption to be considered. Moreover, its configuration permits to favorably size the nacelles in order to improve its performances during all flight phases.

For this purpose, we project, in accordance with the present invention, a convertible aircraft comprising a fuselage, at least a fixed ducted horizontal rotor, called <<horizontal fan>>, located at the front or rear end of the fuselage, a tail-unit comprising a horizontal stabilizer and a fin, at least two wings arranged on each side of the fuselage, and at least a first and a second nacelle arranged at both wingtips each of these nacelles, tilt mounted around a transversal axis with respect to the fuselage, comprises a ducted rotor and a flap, located at the outlet of each ducted rotor in order to ensure the control of the aircraft.

This configuration has many advantages. Firstly it allows providing three support points while the aircraft is hovering, thanks to the two nacelles and the horizontal fan, thus ensuring a perfect stability in the horizontal plane during this flight phase.

Moreover, the availability of the horizontal fan allows the center of gravity of the aircraft to vary in a large range, thus greatly facilitating the longitudinal distribution of the payloads.

During all flight phases, flaps located at the outlet of the ducts can thus be moved in a differential way. The Independent actuation of the flaps combined with the horizontal fan action, provide precise and particularly simple control and trim possibilities for roll, yaw and pitch, and this, regardless of the flight phases. Notably during the transition phase, while the rotation axis of the rotors moves from vertical to horizontal position, the fan ensures that the longitudinal axis of the aircraft remains stable, as the thrust center of the nacelles and the center of gravity are not lined up anymore.

The complexity of the control system is reduced to its minimum and consequently its reliability is improved. In fact, two nacelles each equipped with a control flap is the minimal configuration for convertible aircrafts with ducted rotors, being evident that only one tilting nacelle cannot be considered to propel and control this category of aircraft.

Moreover, the flaps located at the outlet of the nacelles permit to take advantage of a generous and available airflow regardless of the flight phases. Aircraft control can be constantly ensured whatever its forward speed.

On the other hand, the wing allows accommodating the actuation systems of the rotation of the nacelles, the power transmission, and the fuel or any other energy source, without restricting the cabin space.

Finally, this general configuration, closed to a conventional airplane, allows performing take-offs and vertical landings but also horizontal landings from a runway, and ensures a great aerodynamic stability in horizontal flight.

This configuration comes closer in many ways to conventional technical solutions, both cost effective and already certified by the aviation authorities. The invention thus provides the opportunity to mass produce a convertible aircraft which meets the requirements of reliability, production cost and certification rules.

Optionally, the invention furthermore includes at least any of the following features:

The aircraft is fitted with a combustion engine located in the fuselage, preferably behind the wings, and driving the rotors located in the nacelles through a mechanical transmission.

Each nacelle includes a power transmission box as well as means to vary the pitch of the rotor, conferring them the ability, for a given absorbed power, to vary the thrust.

Optionally, the aircraft is fitted with an electric generator coupled with the combustion engine and with an electricity storage system, an electrical transformation system and means to transfer this electricity toward the electric motors integrated in each nacelle.

The aircraft is characterized by the fact that the exhaust gas of the combustion engine are ejected onto the top of the fuselage by an opening allowing the exhaust noise to be transmitted upward, thereby significantly decreasing the sound signature of the aircraft for an observer standing on the ground.

The aircraft is equipped with two air intakes located on top of the fuselage ahead of the wings, supplying the combustion engine with air and ensuring the on-board systems are cooled.

The wings are fixed and implanted at the upper level of the fuselage. Preferably, they are joined on top of the fuselage. The upper layout of the wings allows increasing the size of the nacelles and consequently the total thrust of the propulsion system for a given power. It also allows facilitating the access to the cabin and clears the visibility of the pilot and the passengers.

The wings extend along a substantially perpendicular direction to the aircraft fuselage. Alternatively, they can be swept back.

Aircraft includes a conventional empennage. Particularly, it comprises a horizontal plane called stabilizer and a vertical plane called fin. Favorably, the stabilizer is equipped with elevators, and the fin is equipped with a rudder.

Preferably, the aircraft is fitted with an empennage including a stabilizer and two fins offset at each stabilizer ends. The stabilizer is equipped with elevators, and the fins are equipped with rudders. This configuration allows the horizontal fan to be inserted at the end of the fuselage, and consequently allows a better aerodynamic efficiency in operation. In this way, the horizontal empennage is blown by the nacelles during the transition phase, making it functional when the relative wind does not do it yet.

In addition, the fan is located in the turbulent airflow at the back end of the fuselage, which makes the aerodynamic drag balance of the aircraft less penalizing.

Optionally, the aircraft is fitted with an empennage in V called “butterfly tail”, where the stabilizer and the fin are replaced by two surfaces forming a V, equipped with movable surfaces which are used both as elevator and rudder. This configuration allows, in the same way as the previous one, the horizontal fan to be favorably inserted in the fuselage.

Moreover, the aircraft can include ailerons and/or flaps installed on the wings. All these previously described aerodynamic surfaces are called “conventional control means”.

The nacelles have one or several flaps, which can be moved symmetrically or none symmetrically.

The nacelles and their flaps are arranged at the wingtip, which allows benefiting from a maximum lever arm in order to control and trim the aircraft, hence restricting their size and the power absorbed by the control components.

The first and second flaps are rotationally mounted. They are rotationally mounted around substantially parallel axis to the tilting axis of the first and second nacelle respectively.

Flaps substantially extend along the entire internal section of the nacelle in order to increase their efficiency.

The horizontal fan is integrated at the front or rear ends of the fuselage and can be controlled separately from the two flaps in order to vary its thrust, by varying its pitch or its rotation speed.

Preferably, the horizontal fan is rotated by one or several electric motors.

The aircraft is equipped with control means and their transmission, paired with the flaps, the movable surfaces of the rear empennage, the rotors at the wingtip, and the horizontal fan.

In a second embodiment, the aircraft is configured in such a way that the horizontal fan is located at the front end of the fuselage, in the nose, and that the empennage configuration is a T-tail. The said empennage is made up of a single fin and of only one stabilizer installed on top of the fin, each respectively equipped with a rudder and elevators. The advantage of this type of empennage is to be located outside of the airflow generated by the nacelles, and thus is only subjected to the airflow due to the horizontal motion of the aircraft. The said empennage then generates a control source independent from the nacelles, adding up to it for a reinforced aircraft control.

The aircraft also includes two “canard” wings, located at the front and on each side of the fuselage, in order to balance the aerodynamic forces which apply in horizontal flight.

Favorably, this type of configuration with three plans (canard plane, wings and stabilizer) allows the wings, and thus the nacelles, to be implanted further backward of the cabin, hence clearing the lateral visibility of the passengers and broadening the scope of operations in hovering flight for any kind of mission, particularly for homeland security.

Other features, objectives and advantages of the present invention will arise from reading the following detailed description, and with regards to the attached drawings, given as non-restrictive examples, and on which:

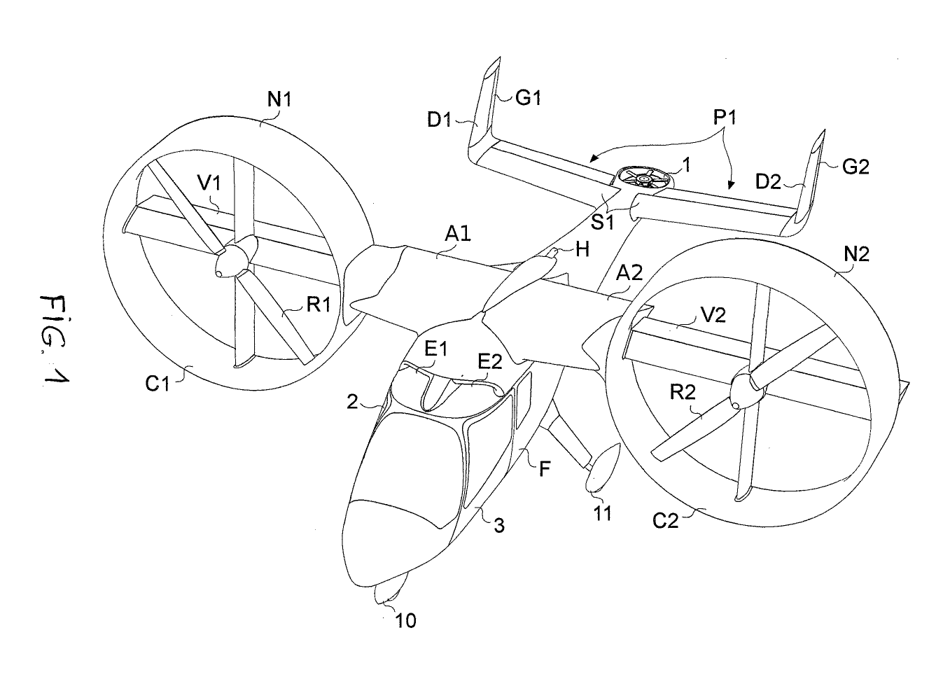

FIG. 1 is a perspective view of an aircraft, the nacelles of which are oriented in plane mode, according to a first embodiment of the invention.

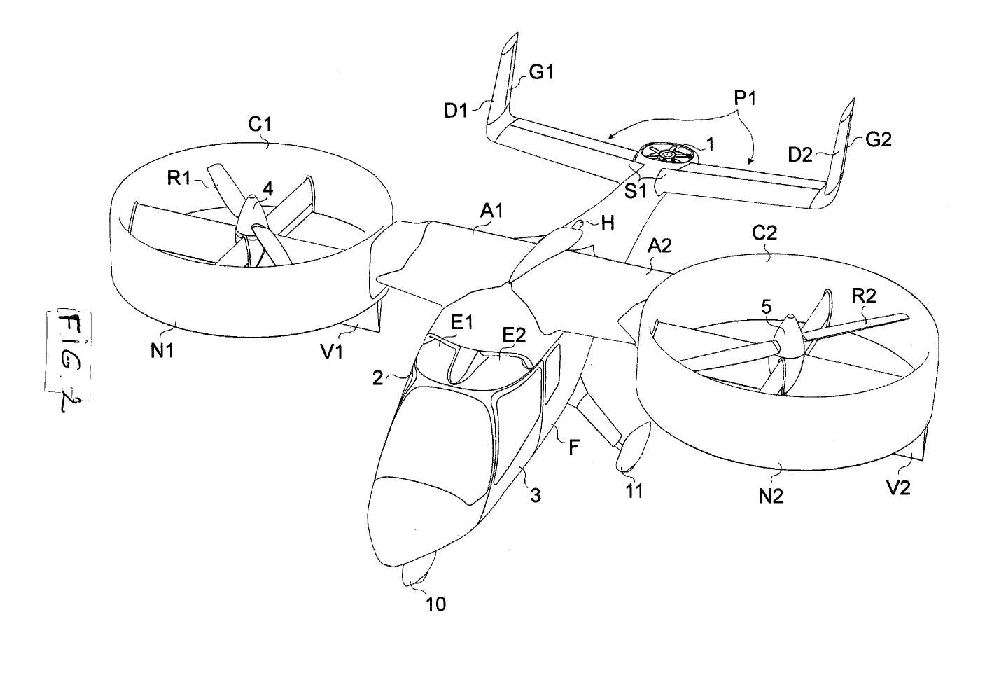

FIG. 2 is a perspective view of the aircraft, the nacelles of which are oriented in helicopter mode, according to a first embodiment of the invention.

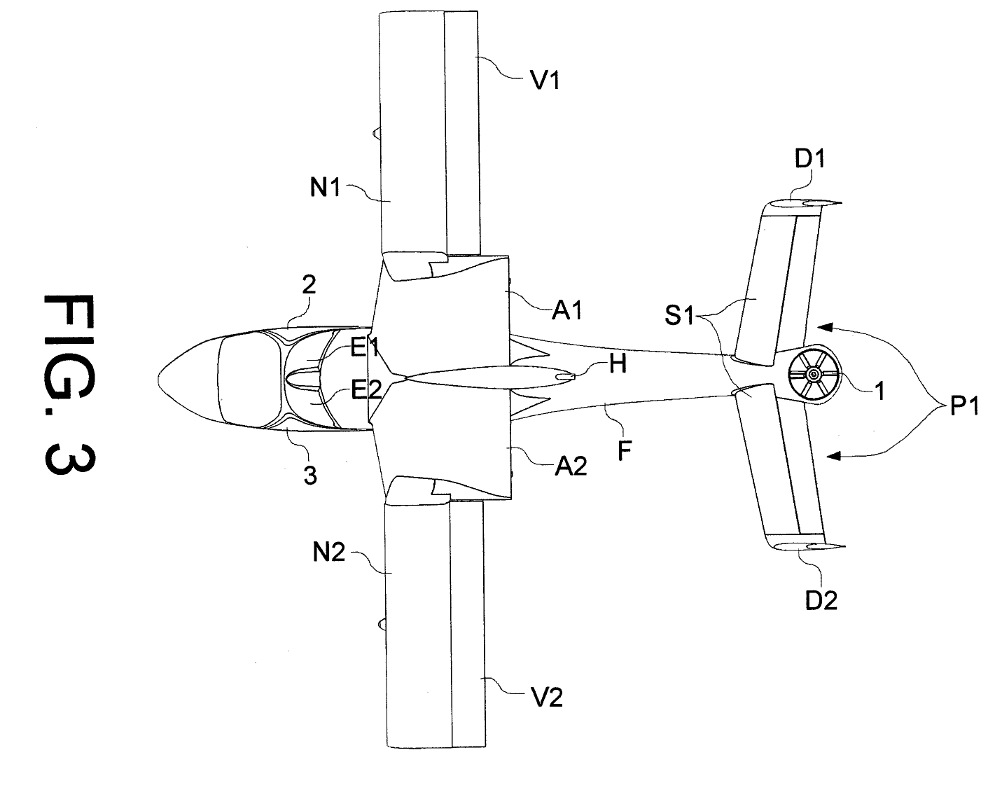

FIG. 3 is an upper view of the aircraft illustrated in FIG. 1.

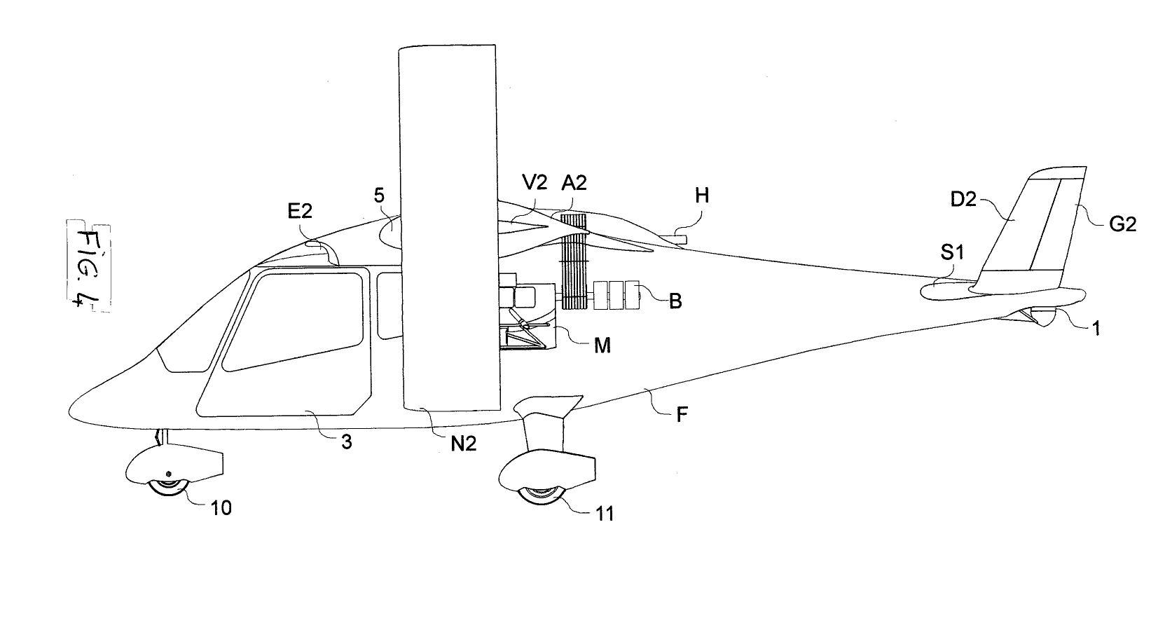

FIG. 4 is a side view of the aircraft illustrated in FIG. 1.

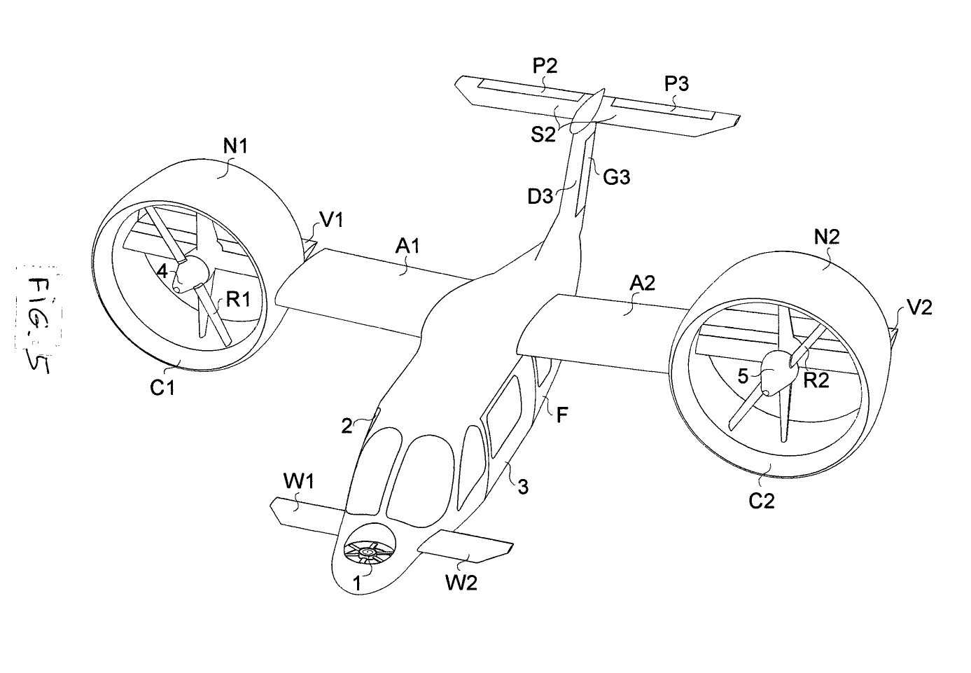

FIG. 5 is a perspective view of an aircraft fitted with a T-tail and two canard wings, according to a second embodiment of the invention.

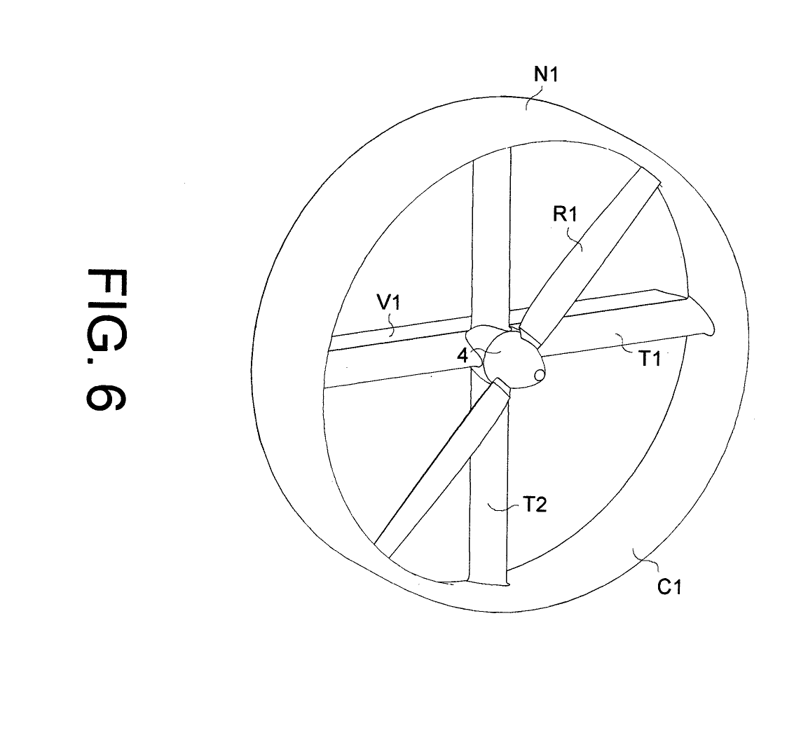

FIG. 6 is a perspective view of a nacelle, according to any embodiment of the invention.

One and the same reference is assigned to the same elements illustrated in several distinct figures.

With regards to FIGS. 1 to 4, the aircraft is illustrated as per first embodiment. This aircraft includes a fuselage F and two wings A1 and A2, arranged on top of the fuselage F. The fuselage F mainly extends along a longitudinal direction bounded by its nose and its tail. The aircraft additionally includes a pair of nacelles N1 and N2 also arranged on each side of the fuselage F, as well as a fixed horizontal fan 1. The aircraft is fitted with an empennage, made of a stabilizer S1 and two fins D1 and D2, respectively equipped with an elevator P1 and two rudders G1 and G2. The aircraft is characterized by the fact that two air intakes E1 and E2, as well as the gas exhaust H of the combustion engine M are located on top of the fuselage F.

With regards to the FIG. 5, the aircraft is illustrated as per second embodiment. This aircraft includes a fuselage F and two wings A1 and A2, located on top of the fuselage F. The fuselage F mainly extends along a longitudinal direction bounded by its nose and its tail. The aircraft additionally includes a set of nacelles N1 and N2 located on each side of the fuselage F, as well as a fixed horizontal fan 1. The aircraft includes a T-tail, made of a fin D3 and a stabilizer S2 installed atop the fin, respectively equipped with a rudder G3 and elevators P2 and P3; the aircraft also includes two “canard” wings W1 and W2 located on the front and on each side of the fuselage, between the horizontal fan 1 and the cabin.

With regards to FIGS. 1, 2, 3, 4, and 5, each nacelle N1 and N2 is a propulsion component of the aircraft. They each include an internal fairing C1 and C2, as well as at least one rotor R1 and R2, fitted with blades and configured to rotate inside each internal fairing C1 and C2.

Both nacelles N1 and N2 are mounted in order to tilt with respect to the fuselage F, and are rotated at the wingtips A1 and A2 along a strictly orthogonal axis to the longitudinal axis of the fuselage F.

Preferably, both wings A1 and A2 are fixed, substantially extending along a transversal direction to the fuselage F, as illustrated in FIGS. 1 to 5, and providing a high implantation.

Favorably, both nacelles N1 and N2 are located at the wingtips A1 and A2. This allows the rotation axis of the rotors R1 and R2 to be positioned at the highest possible point. The upper position of the wings A1 and A2 with respect to the fuselage, combined with the positioning of the nacelles N1 and N2 at the wingtip, allows the size of the said nacelles to be maximized, in order to obtain a higher thrust. As per the present invention, the aircraft offers a bettered accessibility to access openings 2 and 3 of the cabin, in comparison to a low-wing configuration. Moreover, the visibility of the pilot and the passengers are greatly improved.

In term of control, this positioning of the nacelles provides a larger lever arm with respect to the center of gravity and considerably reduces the airflow interactions with the fuselage.

As illustrated in FIG. 1, the aircraft is also configured in such a way that by a first position of the nacelles, the rotors R1 and R2 rotate around a substantially horizontal direction. The aircraft then evolves horizontally and can reach its maximum speed.

As illustrated in FIG. 2, the aircraft is configured in such a way that, by a second position of the nacelles N1 and N2, both rotors R1 and R2 rotate around a substantially vertical direction. The aircraft can then perform vertical takeoffs or landings, hovering or moving horizontally at slow speed for approach flights.

Preferably, both nacelles N1 and N2 are adjustable over an angular sector of about 95° between the helicopter mode and the plane mode. They can be maintained in any intermediate position during any flight phase.

FIG. 6 illustrates the nacelle N1 configuration, similar to the nacelle N2.

The nacelle N1 includes a housing 4 which contains a bevel gear transferring the engine power to the rotor R1, or the electric engines in case of a hybrid generation of the propulsion. The nacelle N1 provides a rotor disc bounded by the inner walls of the fairing C1. The housing 4 is attached to the fairing C1 by means of a cross beam T1, the extremities of which are joined to the fairing C1. Advantageously, the nacelle N1 comprises another cross beam T2 forming a cross inside the fairing C1, in such a way that it stiffens the nacelle N1 and supports the rotor R1. The power transmission shaft is located inside the cross beam T1.

The nacelle N1 can only produce a unique tilting motion with respect to the wing A1; the axis of this tilting being fixed and orthogonal with respect to the fuselage F. This allows the kinematics of the nacelles to be greatly simplified, and so increases the aircraft reliability and restricts the propulsion system weight.

With regards to FIGS. 1, 2, 3, 4, and 5, the aircraft comprises at least two flaps V1 and V2 respectively attached to the nacelles N1 and N2, and located at the airflow output of both rotors R1 and R2 respectively. Each flap V1 and V2 designates an aerodynamic surface, movable around a single axis, used for modifying the airflow at the outlet of the nacelle.

Both flaps V1 and V2 are pivotally mounted with respect to both nacelles N1 and N2. Preferably, both flaps V1 and V2 are pivotally installed around an orthogonal axis to the fuselage F. The pivot axis of the flap V1 is thus substantially parallel to the tilting axis of both nacelles N1 and N2.

Characteristically, both flaps V1 and V2, located on each side of the fuselage F and pertaining to both nacelles N1 and N2 respectively, are configured in such a way that they can be moved in an asymmetrical manner. It shall be stated that in the frame of the present invention, dissymmetry means non symmetrical and does not impose or exclude an identical amplitude of the motion.

Thus only one single flap V1 and V2 can be moved at once, or both flaps V1 and V2 can be moved with identical amplitudes in the same or opposite directions, or either both flaps V1 and V2 can be moved with different amplitudes in the same or opposite directions.

Each flap V1 and V2 pivoting modifies the aircraft behavior. Both flaps V1 and V2 are configured to bring the aircraft from a state of equilibrium to another, and thus contribute to the control and/or to the aerodynamic trim of the aircraft.

As illustrated in FIG. 4, the aircraft is fitted with a combustion engine M located inside the fuselage F, preferably close to the wings A1 and A2, and driving the rotors R1 and R2.

Optionally, the aircraft is provided with an electric generator B combined with the combustion engine M, which permits to generate electricity in order to power the electric motors integrated in the housings (J1, J2) of the nacelles (N1, N2).

As illustrated in FIGS. 1, 2, 3, and 4, the aircraft has a landing gear comprising a nose gear 10 and a central gear 11 made up of two gears; specifically, the aircraft can have a fixed landing gear comprising two metallic skids.

Optionally, the control strategy of the aircraft as per one of the previous features includes at least any of the following features:

The position of the nacelles (N1, N2) always remains symmetrical on either side of the fuselage (F). Thus, roll, pitch and yaw are controlled by differentially or symmetrically operating the position of the flaps (V1, V2), of the conventional control means (P1, P2, D1, D2, D3) of the empennage, as well as by changing the thrust exerted by the horizontal fan (1). Inertia of these control means being almost nil compared to the inertia of a rotating nacelle, the precision of the control system is significantly improved.

Depending on the flight phases, yaw and roll are produced by a thrust dissymmetry generated by each nacelle (N1, N2). In this regards, either an asymmetry in the rotation speed of the rotors (R1, R2) located on either side of the fuselage (F), or an asymmetry of the pitch of the rotors (R1, R2) located on each side of the fuselage (F) can be induced. Specifically, any variation of the pitch of the rotors (R1, R2) associated to a constant rotation speed of the rotors (R1, R2) has the advantage to improve the response of the aircraft control.

To induce a motion mobilizing the least possible energy, the flaps (V1, V2) are moved in opposite or in the same direction with equal amplitudes.

The flaps pivoting (V1, V2), the pitch or the power delivered to both rotors (R1, R2), the horizontal fan (1), and the conventional control means (P1, P2, D1, D2, D3), are coupled by mechanical and/or electric and/or electronic means, thus ensuring a great quality of control and trim of the aircraft in any flight phases.

Particularly, this coupling of all control means permits to conciliate the aircraft control both at very low speed and at high speed. At very low speed the conventional control means (P1, P2, D1, D2, D3) are ineffective because of no air flowing on their surface. But once the aircraft moves at a sufficient speed, they add up to the action of the flaps (V1, V2), the rotors (R1, R2), and the horizontal fan (1) in order to control it.

Specifically, the control of the three axis of the aircraft can be ensured as follows:

In this request, it is considered that a flap (V1, V2) is pivoted toward the rear (upward) when its trailing edge position after pivoting is offset toward the empennage (upward) with respect to its prior position before pivoting. Conversely, a flap (V1, V2) is pivoted toward the front (downward) when its trailing edge position after pivoting is offset toward the nose (downward) of the aircraft with respect to its prior position before pivoting.

### Yaw Control

Asymmetrical activation of both flaps (V1, V2), thrust asymmetry generated by both rotors (R1, R2) and the rudder (D1, D2, D3) of the empennage, allow controlling the aircraft yaw.

In helicopter mode, as illustrated in FIG. 2, when the flap of the nacelle N1 is pivoted backward, as the flap of the nacelle N2 is pivoted forward, the aircraft nose is heading toward the nacelle N2.

In plane mode, as illustrated in FIG. 1, the nacelles move from a vertical orientation to a horizontal orientation. Thus, a higher thrust of the nacelle N1 causes a yaw motion toward the side of the nacelle N2.

From a particularly favorable way, the deflection of both flaps (V1, V2) as well as the thrust asymmetry exerted by both rotors (R1, R2) are coupled with the rudder (D1, D2, D3) located on the empennage in order to control the aircraft yaw during any flight phases.

### Roll Control

Asymmetrical activation of the flaps (V1, V2) and thrust asymmetry generated by the rotors (R1, R2) permit to control the aircraft roll.

In helicopter mode, a greater nacelle thrust N1 causes a roll motion toward the nacelle N2, and vice versa.

In plane mode, when the flap V1 is pivoted upwards and the flap V2 is pivoted downwards, the aircraft experiences a roll motion toward the nacelle N2, just like a conventional airplane.

### Pitch Control

Symmetrical activation of the flaps (V1, V2), thrust asymmetry generated by both rotors (R1, R2), the horizontal fan (1) and the elevator (P1, P2) of the empennage permit to control the aircraft pitch.

In order to do so, both flaps (V1, V2) always remain in symmetrical positions on either side of the fuselage F.

In helicopter mode, a higher thrust of the horizontal fan 1 and/or a backward pivoting of both flaps (V1, V2) allow a downward pitching moment to be generated. Conversely, when the flaps (V1, V2) are moved forward, or when the thrust of the horizontal fan 1 decreases, the aircraft noses up.

In plane mode, an upward pivoting of the flaps (V1, V2) generates an upward pitching moment, while a downward motion of the flaps (V1, V2) generates a downward pitching moment.

From a particularly favorable way, the deflection of the flaps (V1, V2) is coupled with the elevator (P1, P2) located on the empennage in order to control the aircraft pitch.

Optionally, the horizontal fan can be coupled with the autopilot or with any other electronic system in order to maintain a strictly level aircraft attitude in hovering flight, and during the transition phase from the helicopter mode to the plane mode. This allows a more comfortable flying and a better stability.

Control During Transition

In order to understand the following descriptions, “the angle of rotation” of the rotors (R1, R2) is the one formed by the axis of rotation of the rotors (R1, R2) in helicopter mode with respect to the horizontal axis of the fuselage F.

In general, the effect generated by a pivoting of the flaps (V1, V2) depends on the orientation of the nacelles (N1, N2). Whenever their angle of rotation is less than 45°, the motion of the flaps (V1, V2) mainly induces a yaw motion along with a roll motion. Whenever the angle of rotation of the nacelles (N1, N2) is more than 45°, it mainly induces a roll motion along with a yaw motion. Whenever the angle of rotation is equal to 45°, it induces as much roll as yaw.

In general, the effect generated by the thrust asymmetry of the rotors (R1, R2) depends on the orientation of the nacelles (N1, N2). Whenever the angle of rotation is higher than 45°, thrust asymmetry mainly induces a yaw motion along with a roll motion. Whenever the angle of rotation is lower than 45°, it mainly induces a roll motion along with a yaw motion. Whenever the angle of rotation is equal to 45°, it induces as much roll as yaw. Only the coupling of all control means of the aircraft can permit to trim or cancel the side effects.

### Yaw, Roll And Pitch Control By Tilting The Nacelles (N1, N2)

In an alternative mode, which would be an emergency mode, the nacelles (N1, N2) can be moved independently from one another. The pilot can select the nacelles (N1, N2) to be independent. Their symmetrical or asymmetrical motion, in an actuation envelope of approximately 95 degrees with respect to the longitudinal axis of the fuselage (F), can allow the aircraft to be controlled as per the same principle as the flaps (V1, V2).

### Trim

Each motion of the flaps (V1, V2), of the nacelles (N1, N2), any thrust asymmetrical modification of the rotors' thrust (R1, R2), or any thrust modification of the horizontal fan 1, as described herein above, can be used for aerodynamic trim, in order to maintain the aircraft in stable equilibrium at any moment of the flight.

### Effects Induced By The Nacelles (N1, N2)

In the present configuration, the tilting of the nacelles (N1, N2) generates two side effects, called induced, which are required to be compensated. The first one is the gyroscopic precession of the nacelles (N1, N2) during their tilting, which induces a downward pitching moment when they are tilted forward, and an upward pitching moment when they are tilted backward. The second one is the lift variation of the nacelles (N1, N2) according to their angle of tilting. Depending on the forward speed of the aircraft, the airflow impacts the nacelles (N1, N2) and generates a lift which may vary according to their angle of attack and the generated thrust.

In order to compensate these two induced effects, the aircraft is accordingly configured to permit a differential activation of the flaps (V1, V2), of the thrust of the rotors (R1, R2) and of the horizontal fan 1. The aircraft can benefit from an electronic assistance in order to optimize its control.

The invention thus provides an aircraft both substantially as fast and efficient as a cruising airplane, and as controllable as a hovering helicopter. Moreover, thanks to its high wings and ducted nacelles, it is able to land and take off in helicopter mode, much like in plane mode.

The aircraft is also able to maintain a constant speed while descending with a strongly forward inclined attitude, like an airplane. A helicopter would speed up and be forced to quickly modify its trajectory. This feature allows some visibility, speed and precision to be preserved till the landing point.

Compared to the rotor of a helicopter, the nacelles offer the same power/thrust ratio in hovering flight, and thus the same capacities during this flight phase. Unlike a helicopter, the aerodynamic configuration of the aircraft produces lift thanks to its aerodynamic surfaces, and thus allows reaching comparable speeds with less power, inducing de facto more economical operations. Additionally, the forward orientation of the axis of the rotors in horizontal flight allows reaching much higher speeds than a helicopter does.

Because of its configuration with three thrust points in hovering flight, the aircraft is particularly stable. Furthermore, it provides many control and trim means whatever the flight phases, with a very simple construction principle and a better reliability compared to helicopters.

Besides, its noise emissions are very limited, because of its exhaust located on top of the fuselage, and its shrouded propellers emitting high frequency sounds quickly dissipated in the air and not very disturbing for the human ears.

According to the present invention, the aircraft hence stands as a particularly favorable solution for all homeland security, rescue, public or private transport utilizations, and in general for all missions usually requiring helicopters and airplanes.

As a not restrictive instance, an aircraft according to the present invention has a span of 9 meters, a length of 8.50 meters, an empty weight of 1.1 ton and a driving power of 350 horsepower; it offers a payload of around 450 kilograms. Typically, it is designed to have a sitting capacity of 1 pilot and 3 passengers, or fit 1 pilot and 1 cubic meter of freight. It covers a distance of around 800 nautical miles, at around 160 knots.

Of course, the present invention is not limited to the embodiments described above, but covers any embodiment conformal to its spirit.

1. A convertible aircraft comprising a fuselage, and a pair of wings on each side of the fuselage, and a first and a second nacelles respectively located at each wingtip, each comprising a ducted rotor, and pivotally mounted with respect to the fuselage in that it comprises a first and a second movable flap respectively located at the outlet of the ducted rotor of the first nacelle and at the outlet of the ducted rotor of the second nacelle characterized in that it comprises a at ducted rotor installed in horizontal position at any end of the fuselage, and includes a at Vast one combustion engine installed in the fuselage, which is air supplied through the top of the fuselage by means of a first opening, and whose exhaust gas are ejected on top of the fuselage through a second opening.

2. A convertible aircraft in accordance with claim 1, wherein the said wings are in upper position.

3. A convertible aircraft in accordance with claim 1, including two canard wings located on each side of the fuselage.

4. A convertible aircraft in accordance with claim 1, including an empennage provided with a stabilizer and a vertical fin, equipped with an elevator and a rudder.

5. A convertible aircraft in accordance with claim 1, wherein a combustion engine drives, through a mechanical transmission, the rotors located in the nacelles.

6. A convertible aircraft in accordance with claim 1, wherein each nacelle comprises a housing, which accommodates a power bevel gearbox as well as means to vary the pitch of each rotor.

7. A convertible aircraft in accordance with claim 6, wherein an electric generator is coupled with a combustion engine and an electricity storage system, and has means to supply electricity to the electric motors integrated in the housings.

8. A convertible aircraft in accordance with claim 1, wherein each flap extends over substantially the entire inner section of the nacelle where it is installed.
